(19) United States
(12) Patent Application Publication
(10) Pub. No.: US 2003/0160690 A1
(43) Pub. Date: Aug. 28, 2003

(54) Magnetically mountable vehicle hazard device

(76) Inventor: Carl J. Baldwin, Seattle, WA (US)

Correspondence Address: Jan Carol Little, LAW OFFICES OF JAN CAROL LITTLE, P.O. Box 566, Seattle, WA, 98111-0566, US

(21) Appl. No.: 10/082,675

(22) Filed: Feb. 23, 2002

(51) Int. Cl. B60Q 1/52

(52) U.S. Cl. 340/473; 340/471

(57) ABSTRACT

A magnetically mountable vehicle hazard device is mounted to a vehicle, during hazardous conditions, for example. The vehicle hazard device is battery operated and includes a light, a housing, and a flexible magnetic strip such that the device can be magnetically attached to a vehicle's outer surface, yet be rolled up (e.g., as part of an emergency roadside kit) when not in use.

### BACKGROUND OF THE INVENTION

1. Field of the Invention

The present invention is related to hazard lights, and in particular to a magnetically mountable a portable vehicle hazard light.

2. Background Information

State and municipal authorities generally advise motorists to carry emergency roadside kits in their vehicles in case the motorist is in an accident, the vehicle becomes disabled, or in the event that other emergencies occur (e.g., an earthquake). A typical roadside kit contains a flashlight, a first aid kit, blankets, jumper cables, and other items commonly needed during an emergency, such as flares to let other motorists that the vehicle is disabled.

Unfortunately, many people are uncomfortable using flares, either because they do not know how to use them properly or because they are afraid they will be burned. As a result, a stranded motorist is limited to using the installed emergency flashers to warn other motorists or to assist emergency response personnel in locating the vehicle.

The installed emergency flashers are part of the standard taillights (and headlights), which are located on the lower portion of the vehicle. This is problematic because approaching vehicles cannot see the flashing taillights until they are quite close to the disabled vehicle. What is needed, therefore, are improvements over flashing taillights and emergency flares.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a perspective view of a vehicle hazard system according to an embodiment of the present invention;

FIG. 2 is a perspective view of the vehicle hazard device in FIG. 1 according to an embodiment of the present invention; and

FIG. 3 is an exploded perspective view of a vehicle hazard device in FIG. 2 according to an embodiment of the present invention.

### DETAILED DESCRIPTION OF THE ILLUSTRATED EMBODIMENTS

Embodiments of the present invention are directed to a vehicle hazard device. In the following description, numerous specific details, such as particular processes, materials, devices, and so forth, are presented to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring embodiments of various embodiments of the invention.

Some parts of the description will be presented using terms such as housing, light source, magnet, and so forth. These terms are commonly employed by those skilled in the art to convey the substance of their work to others skilled in the art.

Various operations will be described as multiple discrete blocks performed in turn in a manner that is most helpful in understanding the invention. However, the order in which they are described should not be construed to imply that these operations are necessarily order dependent or that the operations be performed in the order in which the blocks are presented.

Reference throughout this specification to “one embodiment” or “an embodiment” means that a particular feature, structure, process, block, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

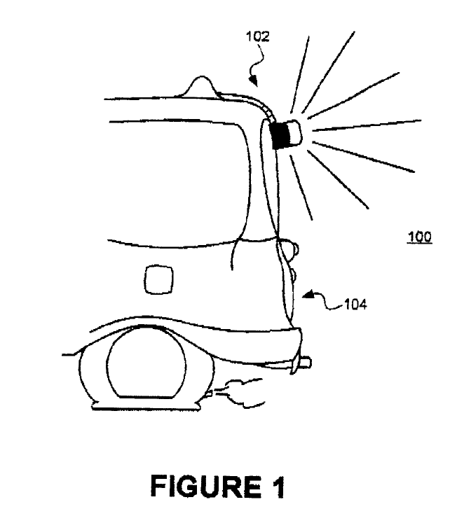

FIG. 1 illustrates a vehicle hazard system 100 according to an embodiment of the present invention, in which a vehicle hazard device 102 is attached to a vehicle 104. The vehicle hazard device 102 is magnetically mountable to the outside of the vehicle 104 for the purpose of warning other motorists or assisting emergency response, roadside assistance, or other personnel in locating the vehicle. The magnetic portion of the vehicle hazard device 102 is made of a flexible magnetic material such that the vehicle hazard device 102 readily conforms to the contour of the vehicle 104. The material of the magnetic portion of the vehicle hazard device 102 also is sufficiently flexible so that the magnetic portion can be wrapped around the vehicle hazard device 102 for storage, in a roadside emergency kit, for example. Additionally, the magnetic portion of the vehicle hazard device 102 may be covered with a soft fabric-like material to reduce the chances that the vehicle hazard device 102 mars the finish on the vehicle. Thus, the vehicle hazard device 102 provides a protective barrier between itself and the vehicle 104.

According to an embodiment of the present invention, the vehicle hazard device 102 is battery operated. In this embodiment, the vehicle hazard device 102 is independent from the vehicle 104's standard lighting systems (e.g., emergency flashers, headlights, taillights, dome lights). In this and other respects, the vehicle hazard device 102 differs from prior art hazard devices. Unlike emergency lights in police cars, for example, the vehicle hazard device 102 is not powered via hardwires or cables. As a result, no power from the vehicle 104 (e.g., vehicle 104 battery or electrical system) is needed to operate the vehicle hazard device 102. An advantage of these and other features is that when the car battery is dead or the car is off, the vehicle hazard device 102 will still function. Also, because the vehicle hazard device 102 does not have to be plugged into the vehicle 104's cigarette lighter the windows do not have to be open to use the vehicle hazard device 102. This feature is useful when the vehicle hazard device 102 is operated in cold or rainy weather conditions.

Alternatively, the vehicle hazard device 102 is adapted to receive power from an alternative power source, such as a cigarette lighter in the vehicle 104. In this embodiment, the vehicle hazard device 102 may receive power via an EXT coupler 230.

In the illustrated embodiment, the vehicle hazard device 102 is located on the top back of the vehicle 104. If the vehicle 104 were located on the side of the road, placing the vehicle hazard device 102 on the top back of the vehicle 104 would allow passing motorists to spot the vehicle 104 more easily.

Of course, the present invention is not limited to this embodiment. For example, the vehicle hazard device 102 could be located in the front of the vehicle 104. This could be the case when the vehicle 104 is facing in a direction other than that which traffic is flowing.

Alternatively, the vehicle hazard device 102 could be located in the top of the vehicle 104. For example, if the vehicle 104 were in a wooded area, placing the vehicle hazard device 102 on the top of the vehicle 104 would allow a helicopter or other airborne vessel to spot the vehicle more easily. Likewise, if the vehicle 104 were in a ravine, placing the vehicle hazard device 102 on the top of the vehicle 104 would allow passing motorists to spot the vehicle more easily.

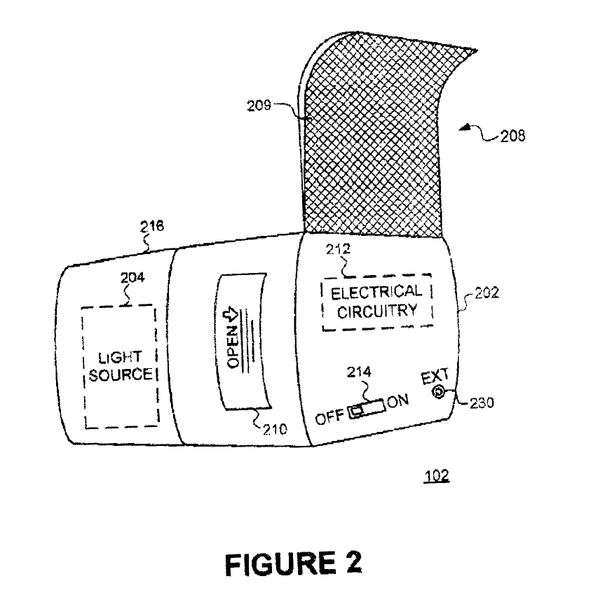

FIG. 2 illustrates an example vehicle hazard device 102 in more detail according to an embodiment of the present invention. For example, the vehicle hazard device 102 may include a housing 202, a light source 204 disposed in the housing 202, and a flexible magnet 208 disposed on the housing 202.

The light source 204 may include one or more light emitting devices, such as light bulbs, light emitting diodes, or other suitable light-emitting device. The light source 204 may emit red, yellow, white, or other suitable color (or wavelength) of light.

In one embodiment, the light emitted is white and the light source 204 has a cover 216, which may be colored yellow, red, or other suitable color. The cover 216 may be made from plastic. The flexible magnet 208 may be made from any flexible polymeric-based magnetic structure designed to allow repeated engagement and disengagement of the vehicle hazard device 102 to and from the vehicle 104, respectively. The flexible magnet 208 is made from a flexible magnetic material such that the flexible magnet 208 readily substantially conforms to the contour of the vehicle 104. The material of the flexible magnet 208 also is sufficiently flexible so that the magnetic portion can be wrapped around the outer circumference of the vehicle hazard device 102. Additionally, the flexible magnet 208 may be covered with a soft fabric mesh 209 to reduce the chances that the flexible magnet 208 scratches the surface of or otherwise mars the finish on the vehicle 104.

The housing 202 may be made from plastic or other suitable material. The housing 202 may have a variety of shapes, including rectangular, triangular, round, elliptical, or polygonal.

The housing 202 also includes a battery compartment cover 210 and electrical circuitry 212. The battery compartment cover 210 opens to store one or more batteries, which provide power to the vehicle hazard device 102 via the electrical circuitry 212.

The electrical circuitry 212 may be configured to cause the light source 204 to illuminate. In one embodiment, the electrical circuitry 212 may be configured to cause the light source 204 to blink or flash.

The housing 202 may include an “on-off” switch 214, which when on causes power from batteries or other power source to be connected to the light source 204 via the electrical circuitry 212 to illuminate the light source 204.

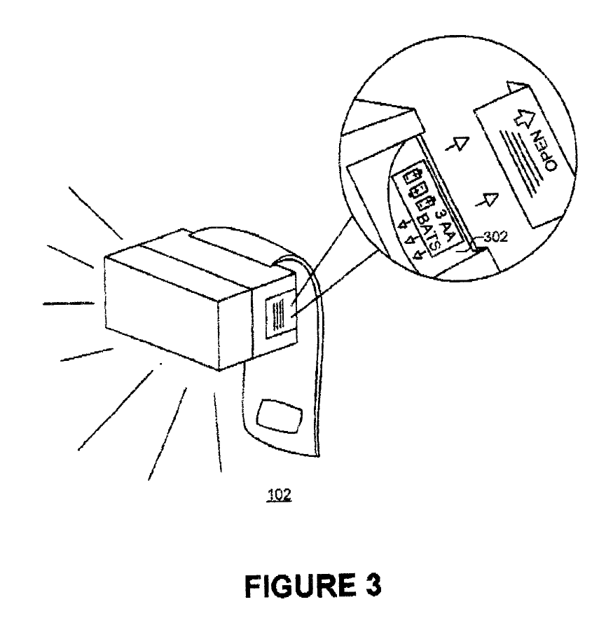

FIG. 3 is an exploded view of the housing 202 according to an embodiment of the present invention. In the illustrated embodiment, the battery compartment cover 210 is removed and a battery receptacle 302 is revealed. According to an embodiment, three AA batteries can be disposed in the battery receptacle 302. When three AA batteries are disposed in the battery receptacle 302 and the “on-off” switch 214 is in the “on” position, the light source 204 illuminates.

The manner of usage and operation of the vehicle hazard device 102 will be readily apparent to persons of ordinary skill in the relevant arts after reading the description herein. Accordingly, no further discussion relating to the usage and operation of the vehicle hazard device 102 will be provided.

Embodiments of the invention can be implemented using hardware, software, or a combination of hardware and software. Such implementations include state machines and application specific integrated circuits (ASICs). In implementations using software, the software may be stored on a computer program product (such as an optical disk, a magnetic disk, a floppy disk, etc.) or a program storage device (such as an optical disk drive, a magnetic disk drive, a floppy disk drive, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a vehicle hazard device having:
a housing; and
a light source disposed in the housing; and
a flexible magnet disposed on the housing.

2. The apparatus of claim 1, wherein the housing includes circuitry operatively coupled to provide power to the light source from a power source.

3. The apparatus of claim 1, further comprising a mesh fabric disposed over the flexible magnet of claim 2, further comprising an anode in contact with the P-type material.

4. The apparatus of claim 3, further comprising hook and loop fasteners disposed on the mesh fabric to maintain the flexible magnet wrapped around the housing.

5. The apparatus of claim 1, wherein the light source comprises at least one cover disposed over the light source.

6. The apparatus of claim 2, wherein the housing further comprises a battery compartment and wherein the circuitry is operatively coupled to the battery compartment.

7. The apparatus of claim 1, wherein the housing is round in shape.

8. The apparatus of claim 2, wherein the circuitry operatively coupled to provide power to the light source from a power source includes circuitry operatively coupled to provide power to the light source from a motor vehicle battery.

9. The apparatus of claim 2, wherein the circuitry operatively coupled to provide power to the light source from a power source includes circuitry operatively coupled to cause the light source to blink.

10. The apparatus of claim 1, wherein the light source is operatively coupled to blink.

11. An apparatus, comprising:
a vehicle hazard device having a housing, a light bulb disposed in the housing, and a flexible magnet disposed on the housing, wherein the housing includes a battery compartment to receive a battery, wherein the light bulb is operatively coupled to receive power from at least one battery disposed in the battery compartment, wherein the flexible magnet includes a mesh fabric disposed over the flexible magnet.

12. The apparatus of claim 11, wherein the housing is triangular in shape.

13. The apparatus of claim 11, wherein the mesh fabric includes hook and loop fasteners.

14. An apparatus, comprising:
a flexible magnet disposed on the housing, wherein the flexible magnet includes a fabric-like cover.

15. The apparatus of claim 14, wherein the housing includes circuitry operatively coupled to provide power to the illumination means from a power source.

16. The apparatus of claim 15, further comprising hook and loop fasteners disposed on the mesh fabric to maintain the flexible magnet wrapped around the housing.
